(19) United States
(12) Patent Application Publication
(10) Pub. No.: US 2014/0095690 A1
(43) Pub. Date: Apr. 3, 2014

(54) REAL TIME RULES ENGINE FOR POLICIES ORCHESTRATION IN A MOBILE TELECOMMUNICATIONS NETWORK

(71) Applicants: Daniel Saker, La Ville du Bois (FR); Shishir Modi, Pickerington, OH (US); T. J. Ivinjack, River Forest, IL (US)

(72) Inventors: Daniel Saker, La Ville du Bois (FR); Shishir Modi, Pickerington, OH (US); T. J. Ivinjack, River Forest, IL (US)

(73) Assignee: Alcatel-Lucent USA Inc.

(21) Appl. No.: 13/630,405

(22) Filed: Sep. 28, 2012

(51) Int. Cl. G06F 15/173

(52) U.S. Cl. 709/224

(57) ABSTRACT

A method is provided for creating a configurable workflow in a mobile telecommunications network ecosystem including a plurality of diverse ecosystem components (400). The method includes: establishing a pipeline (200) that defines the workflow through which a user's data session is processed; and defining a set of workers (202) within the pipeline (200) that sequentially interact in real time with the ecosystem components (400).

### BACKGROUND

The present inventive subject matter relates generally to the art of mobile and/or wireless telecommunications. Particular but not exclusive relevance is found in connection with 3G (3^{rd} Generation) and LTE (Long Term Evolution) wireless networks, and accordingly the present specification makes specific reference thereto. It is to be appreciated however that aspects of the present inventive subject matter are also equally amenable to other like applications and/or network environments.

Using 3G and LTE wireless networks, there are new business models emerging involving mobile network operators (MNOs) or wireless service providers, subscribers or end users and 3^{rd} party content providers. However, in conventional mobile telecommunication networks, interactions between an Online Charging System (OCS) and a Policy and Charging Rules Function (PCRF) generally enable monetization of a user's data session conducted over the mobile telecommunication networks based on only two policy dimensions, namely, the tariff and the bandwidth or Quality of Service (QoS).

Accordingly, it would be desirable to have a system and/or solution to derive additional value from network components during the processing of a user's data session, and/or orchestrate derived value to influence policy decisions in multiple dimensions, i.e., create differentiators according to various dimensions, e.g., such as tariff, QoS/bandwidth, usage, loyalty, location, notification, usage context, etc. This solution provides operators a powerful tool to for growing revenues through the exposure of new service offers defined across multiple systems in the network. Contextual offer management allows communicating the availability of new services within right opportunity window and at right time to increase subscription rate. It enables services providers to sell additional services by pushing relevant options when needed by customers and according their usage context. All in empowering customers with the control and choice to online-subscribe and self-activate services according their needs and preferences. It offers new solution to facilitate rollout of new services tailored to subscriber's needs with real time notification and contextual offer management for immediate service exposure according subscriber's preferences and usage context to increase their adoption. It improves subscriber connected experience with smart self-care for real time interaction and control over their account and subscription to get their confidence and engagement

Accordingly, a new and/or improved system and/or method is disclosed which addresses the above-referenced desire(s) and/or others.

### SUMMARY

This summary is provided to introduce concepts related to the present inventive subject matter. This summary is not intended to identify essential features of the claimed subject matter nor is it intended for use in determining or limiting the scope of the claimed subject matter.

In accordance with one embodiment, a method is provided for creating a configurable workflow in a mobile telecommunications network ecosystem including a plurality of diverse ecosystem components. The method includes: establishing a pipeline that defines the workflow through which a user's data session is processed; and defining a set of workers within the pipeline that sequentially interact in real time with the ecosystem components.

In accordance with other embodiments, an apparatus is provided that executes the foregoing method and/or a non-transitory machine-readable medium is provided including a computer program which when executed performs the foregoing method.

In accordance with another embodiment, a rules engine is provided for creating a configurable workflow in a mobile telecommunications network ecosystem including a plurality of diverse ecosystem components. The rules engine includes: a pipeline defined therein that defines the workflow through which a user's data session is processed; and a set of workers defined within the pipeline that sequentially interact in real time with the ecosystem components.

Numerous advantages and benefits of the inventive subject matter disclosed herein will become apparent to those of ordinary skill in the art upon reading and understanding the present specification.

### BRIEF DESCRIPTION OF THE DRAWING(S)

The following detailed description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a diagrammatic illustration showing exemplary interactions of a rules engine with various different network ecosystem components and/or network elements.

FIG. 2 is a diagrammatic illustration showing an exemplary network architecture suitable for practicing aspects of the present inventive subject matter.

FIG. 3 is a diagrammatic illustration showing an exemplary pipeline having a sequence of workers therein in accordance with aspects of the present inventive subject matter.

FIG. 4 is a diagrammatic illustration showing one particular exemplary pipeline having a sequence of workers therein interacting with various different components of a network ecosystem in accordance with aspect of the present inventive subject matter.

### DETAILED DESCRIPTION OF THE EMBODIMENT(S)

For clarity and simplicity, the present specification shall refer to structural and/or functional elements, relevant standards and/or protocols, and other components that are commonly known in the art without further detailed explanation as to their configuration or operation except to the extent they have been modified or altered in accordance with and/or to accommodate the preferred embodiment(s) presented herein.

As is understood in the art, a user of a mobile device or UE may select to access data from a third party content provider. For example, the user may download or stream music, videos, applications or other content to their mobile device or UE from a provider's Application Server (AS). Generally, this involves establishing a user data session wherein data is transported over a network operator's mobile telecommunications network. Described herein are a Rules Engine (RE), system and/or method for processing a user data session. The described RE, system and/or method allows a network operator to derive added value from processing the user's data session via real time interactions with various network elements and/or components of the network ecosystem in the network operator's environment. The network ecosystem, e.g., includes all the various network elements and/or nodes of the mobile telecommunications network as well as the various adjunct systems and information technology (IT) elements and/or components that interact therewith. For example, the network ecosystem may include, without limitation: the network operator's OCS; network elements such as the PCRF, PGW, GGSN, etc.; a Mobile Wallet (M-Wallet) system or the like; content delivery platforms and/or application servers; loyalty management systems; analytics and reporting systems; Yield Management (YM) and/or Zone Management (ZM) systems, e.g., such as the Instant Zone (IZO) system commercially available from Alcatel-Lucent or the like; care and self-care systems; etc.

In suitable embodiments, information derived from interactions with the foregoing ecosystem components and/or network elements during the processing of the user's data session is employ to orchestrate and/or influence policy decisions in accordance with multiple parameters and/or policy dimensions. For example, the parameters and/or policy dimensions which can be used to orchestrate and/or influence policy decisions, may include, without limitation: a user, application, device and/or subscription profile; the tariff; QoS and/or bandwidth; usage volume; time and/or date; loyalty indicators and/or profile; user location and/or location profile; notifications; usage context; business intelligence; etc.

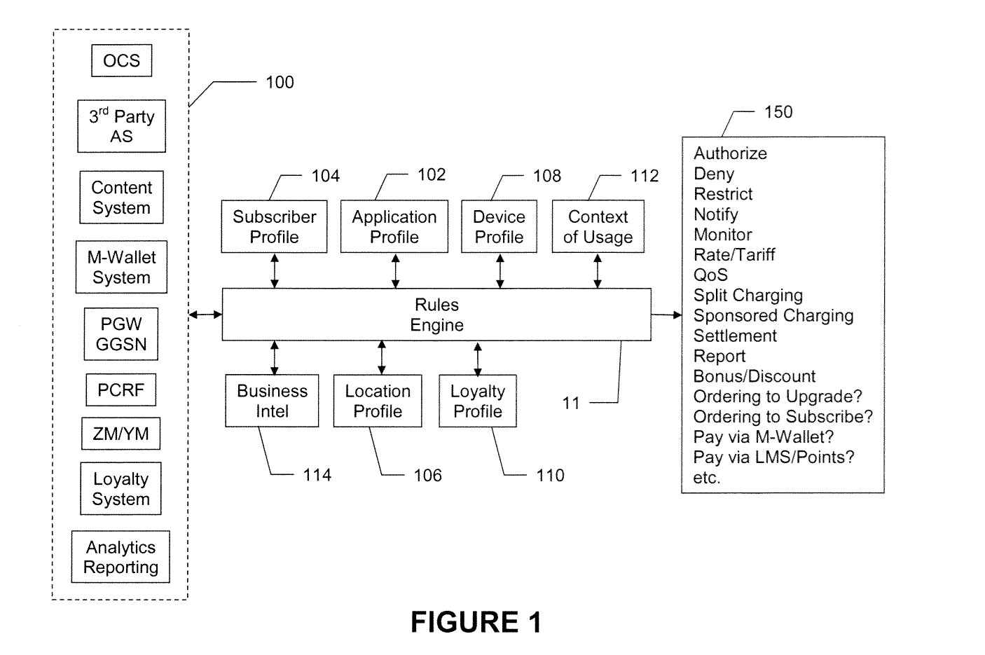

In practice, the RE, system and/or method are used to configure multiple real time pipelines or workflows of business and/or other processes which involve a sequence of interactions that the user's data session may have with ecosystem components and/or network elements. Suitably, rules are defined and executed by the RE to select one of the multiple real time pipelines or workflows that a user's context will go through based on multiple inputs derived from various sources. Through real time orchestration of interactions with multiple elements in the operator's ecosystem, it enables the interaction with relevant systems in the network to maximize derived values, to create differentiation and to transform it into revenue. It coordinates this interaction starting from incoming event (like usage crossed threshold, cell load change, access to online gaming URL) to maximize derived value to have more holistic context about customer, services and network. It allows having holistic view taking into account values derived from subscriber's profile, device, application and network to be better serve subscriber. Derived values are put at service of operator's to set up business rules to deliver real time contextual offers adapted to usage context and to facilitate user's engagement and rights enforcements. It extend network edges to include subscriber's devices through smart client to coordinate user's interaction with network and back-end systems to execute pre-configured rule-based business process. This allows producing a cohesive set of functionality to infer the decision and trigger actions (like notifying user, pushing contextual in-house gaming package with best QoS, etc.) according more holistic context and business rules. For example, when user access a 3rd part URL for online gaming or video streaming, type of service is important for rating and charging but also it is valuable information that can be linked with other parameters from subscriber's profile, service provider's product catalogue and network load. It would be an opportunity for up and cross selling to identify similar offering package in product catalogue corresponding to user's preferences with enhanced bandwidth that can be pushed in real time associated with enhanced quality of service depending in network status. For example, FIG. 1, shows a RE 11 monitoring user data session interactions and/or communicating with various components and/or network elements of a network ecosystem 100 (e.g., including a OCS, third party AS, content system, M-Wallet system, PGW/GGSN, PCRF, ZM/YM, loyalty system, analytics report, etc.). Other inputs can be obtained from and/or interactions monitored with: an accessed application and/or service profile 102; a subscriber profile 104 (e.g., including a subscriber's data plan and/or a subscription profile); a subscriber's current location profile 106; a subscriber's current device profile 108; a subscriber's loyalty profile 110; a context of usage 112 (e.g., whether coming from network parameters or values derived from other systems); and business intelligence 114 (e.g., related to business segmentation, subscriber segmentation, etc.). For example, the application profile 102 may include data such as an identifier, sponsor status, subscription type, metering type, rating plan, media type, recommended QoS, recommended device, etc. The device profile 108 may include such data as an international mobile equipment identity (IMEI), a device type, device name, device manufacturer, operating system (OS) type and/or version, supported radio type (4G, 3G, WiFi, 2G, near field communication (NFC), . . . ), subscriber identity module (SIM), international mobile subscriber identity (IMSI), supported push bearers (wireless application protocol (WAP), short message service (SMS), multimedia messaging service (MMS), unstructured supplementary service data (USSD), . . . ), etc. The location profile 106 may include the home and/or visitor public land mobile network (HPLMN/VPLMN) identifier, the cell Id of the cell being used, the load on the cell being used (e.g., expressed as a percent of the maximum cell load), a discount for using the cell (e.g., expressed as a percentage of the normal rate or tariff), etc. The context of usage 112 may include information such as the date and/or time (e.g., expressed as peak or off-peak), consumption status, credit status, loyalty status, location, device, etc. The subscriber profile 104 may include information such as the subscriber's age, loyalty status (e.g., length of subscription, level, etc.), charging mode, offer plan type (e.g., premium, gold, silver, . . . ), average revenue per user (ARPU) profile (e.g., high, low, etc.); access rights (e.g., Terms of Service (ToS), Time of Delivery (ToD), Day of Week (DoW), location, Terms of Usage (ToU), etc.), forbidden and/or white list, subscriber location, account type (e.g., personal, professional, group, . . . ), usage status, credit status, payment mode (e.g., Credit Card (CC), bank, top-up, . . . ), device type (e.g., smart phone, laptop, 3G key, . . . ), influencing cardinality (e.g., account number, group number, . . . ), etc. As shown in FIG. 1, various policy decisions and/or outcomes 150 may be affected by the multiple inputs and/or multiple conditions. For example, these policy decisions and/or outcomes may relate authorization, service denial or restriction, redirection, notification, monitoring, rate/tariff setting, QoS, split charging, sponsored charging, settlement, reporting, the providing of a bonus and/or discount, ordering an upgrade or subscription, payment processing via M-Wallet or loyalty management system (LMS) points, etc.

More specifically, multiple inputs are evaluated by the RE 11 according to defined rules (i.e., multiple conditions) to control processing of the user's data session. The evaluation of the rules in this manner leads to policy decisions and/or outputs that select the next step of interaction and/or enrich resulting output policies for controlling processing of the user data session. Accordingly, network operators are provided the ability to differentiate according to multiple dimensions of policies. The real time interaction during the processing of user data sessions allows a network operator to derive additional value from the operator's network and/or the associated ecosystem. The RE 11 evaluates derived values with preconfigured conditions thereby leading to multiple decisions creating differentiation via multiple dimensions of policies (e.g., per subscriber, per location, per device, per subscription, per application, per usage context, etc.).

In practice, the RE 11 has real time interactions with various network elements (e.g., such as the PCEF, GGSN and/or PGW) during the processing of a user's data session. Additionally, in real time, the RE 11 may monitor interactions with the OCS of the network operator and/or derive values therefrom which affect policy decisions based on multiple dimensions and/or parameters related to the charging of a user's access to a service based on a subscriber profile, a subscriber offer profile, credit level, state, location, usage consumption, allowed usage context, etc. Also, real time interactions with the PCRF may likewise be enabled to account for network QoS and bandwidth control dimensions.

Also, real time interactions with zoning management and/or yield zone management may be enabled to derive values related to a location policy dimension. For example, dynamic pricing control may be implemented to propose a percent or other discount if a subscriber's originating cell is not overloaded. Suitably, dynamic pricing may vary according to the origin area or cell Id of the data session initiated by the subscriber or according to the cell Id load. In another example, dynamic QoS control may be implemented to propose a QoS booster with additional revenue for the network operator if the subscriber's origination cell is not overloaded. Suitably, the network bandwidth control may vary according to the origin subscriber cell Id and cell load. In still another example, it may be proposed to use a different or delayed download method with a discount if the user's origin cell or location is overloaded to avoid network congestion and reach a better network usage regulation.

In one suitable embodiment, real time interactions during the processing of a user's data session are enabled with a loyalty system to derive values related to a loyalty policy dimension. For example, bonuses, discounts and/or promotional awards may be provided according a subscriber's loyalty. In another example, there can be ensured completeness of data session continuity and/or a data transaction based on pre-configured rules to enable converting available loyalty points into data allowances.

In another example, real time interactions during the processing of a user's data session are enabled with a M-Wallet system for affecting and/or monitoring payment policies, e.g., related to: selecting an M-wallet as a default account for content purchases and/or selecting the OCS as a default account for data access transport across the network and/or pre-configured rules to allows usage of an M-Wallet account if no credit is available in an OCS account to ensure transaction completeness and data session continuity and/or to allows subscription fee payment from an M-Wallet account.

As already eluded too herein, real time interactions are enabled with the PCEF, OCS, PCRF and sponsored data AS. Suitably, this allows for the derivation of values that can be used to create differentiation related to operator owned services and sponsored services to apply a corresponding sponsoring scheme, e.g., sponsored charging or split charging between user and content providers or between operator and content provider or between split charging company and subscriber.

In one exemplary embodiment, real time interactions are also enabled with respect to certain business intelligence, e.g., to enable pushing (during a user's data session and its usage context) an existing operator's promotional plan that is applicable to the current usage context (location, device, accessed application) that may result in up-selling of additional data offers and plans like: pushing QoS booster when a user is streaming video, or proposing a promotional offer when a user is accessing frequently a specific uniform resource locator (URL), or proposing a zoning offer if a user is accessing frequently from the same location, or proposing a discount or bonus if a user is segmented as at risk of switching network operators because of several complaints regarding coverage, or proposing an upgrade to upper plan if a user is segmented of high ARPU because of paying frequently overage (e.g., to avoid bill shock and/or risk of switching to another network operator), etc.

In still one more case, real time interactions with smart self-care may be enabled to put customers in control of their services, account, consumption follow up, and managing their multiple accounts (personal account, professional account family account, etc.).

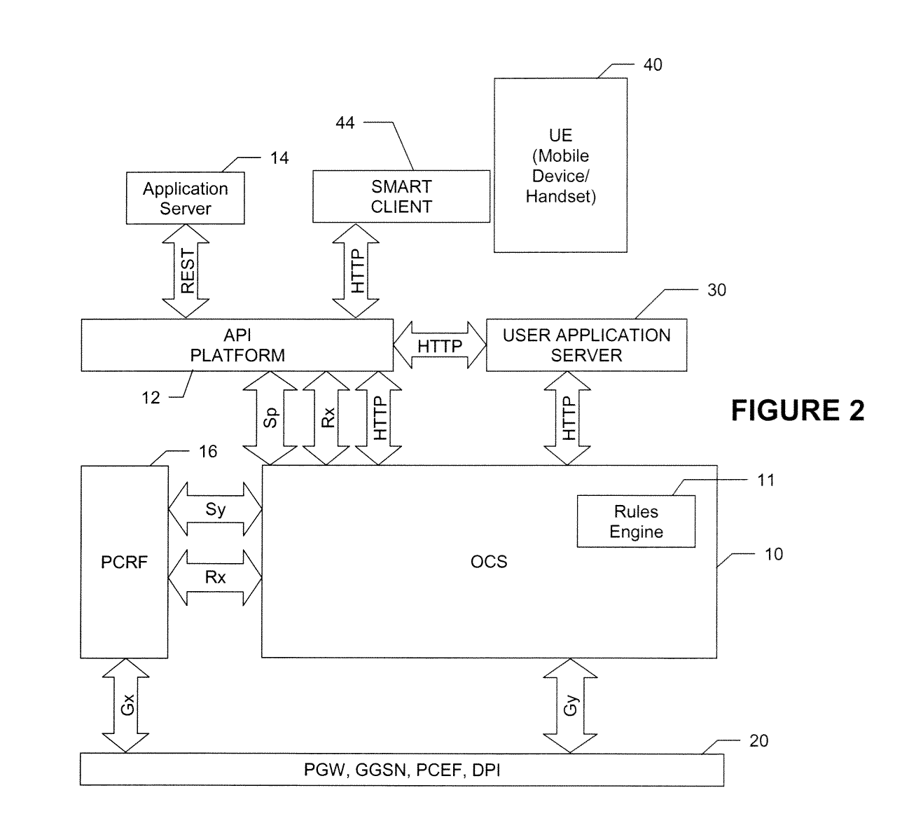

With reference now to FIG. 2, there is shown one exemplary network architecture of a mobile telecommunications network suitable for practicing aspects of the present inventive subject matter. As shown, the architecture includes the aforementioned Rules Engine (RE) 11, which may be, e.g., a part of and/or incorporated in an OCS 10 of a network operator. The OCS 10 and/or RE 11 are linked to and/or otherwise in operative communication with an exposed Application Programming Interface (API) platform 12, e.g., via a suitable hypertext transfer protocol (HTTP) interface or the like, a suitable Diameter Sp interface or the like and/or a suitable Diameter Rx interface or the like. In turn, the API platform 12 is linked and/or otherwise in operative communication with a third party content provider's AS 14, e.g., via a suitable representational state transfer (REST) interface or the like.

As shown, suitable Diameter Sy and Rx interfaces or the like interconnect and/or otherwise link a PCRF 16 and the OCS 10 and/or RE 11 to one another. Suitably, via a Diameter Gy interface or the like, the OCS 10 and/or RE 11 are linked and/or otherwise in operative communication with the general packet radio service (GPRS) core 20 (e.g., including a packet data network gateway (PGW) 22, a PCEF 24, a gateway GPRS support node (GGSN) 26 and a deep packet inspection (DPI) part 28). Likewise, the PCRF 16 is linked and/or otherwise in operative communication with the GPRS core 20 via a suitable Diameter Gx interface or the like.

In the illustrated embodiment, a user application server (UAS) 30 is linked and/or otherwise in operative communication with the OCS 10 and/or RE 11 and the API platform 12, e.g., via HTTP interfaces or the like. Also shown, is a handset or client device or UE 40 (e.g., such as a smart phone or the like). The handset or client device or UE 40 is suitably equipped and/or otherwise provisioned with a smart client or client application 44 residing and/or operational on the handset or client device 40. As shown, an HI IP interface or the like interconnects and/or otherwise links the smart client application 44 with the API platform 12.

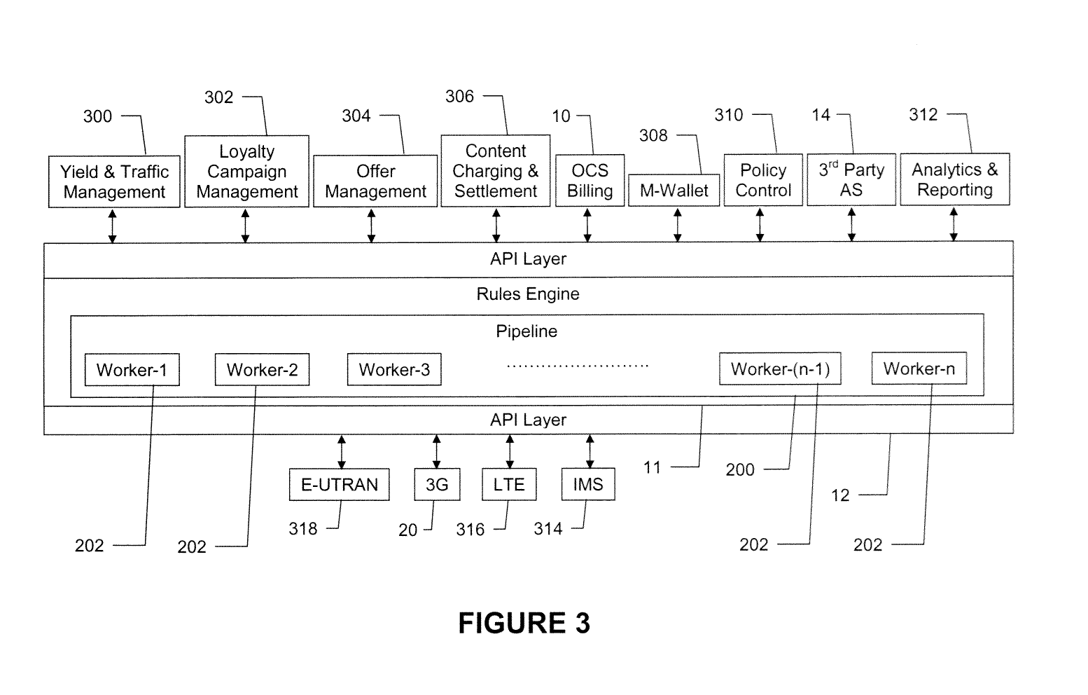

As previously eluded to herein, the RE 11 allows the configuration of one or more pipelines or workflows of business or other processes which involve a sequence of interactions that a user's data session may have with ecosystem components and/or network elements. With additional reference to FIG. 3, there is shown an example of such a pipeline. As illustrated, a single pipeline 200 is established in and/or by the RE 11. Suitably, via the exposed API 12, the RE 11 is in communication with and/or otherwise linked to a plurality of diverse ecosystem components and/or network elements as shown via suitable interfaces. In the illustrated embodiment, the ecosystem components and/or network elements include: a yield and traffic management system 300; a loyalty campaign management system 302; an offer management system 304; a content, charging and settlement system 306; an OCS 10; a M-Wallet system 308; a policy control part 310; a third party AS 16; an analytics and reporting system 312; an IP Multimedia Subsystem (IMS) 314; an evolved packet core (EPC) 316 of an LTE network (including its usual network elements and/or components, e.g., such as a Packet Data Network (PDN) gateway and PCRF); a 3G network core 20 (including its usual network elements and/or components, e.g., such as a PCRF and GGSN); and an Evolved Universal Terrestrial Radio Access Network (E-UTRAN) 318.

In the illustrated embodiment, the pipeline 200 includes a plurality of “workers” 202. The pipeline 200 defines the sequence of interactions with the various ecosystem components and/or network elements that the user's data session may have from the beginning until the end of the session according to a given scenario of data usage, properties of the subscribed data plan and evolution of the context of usage. In turn, each “worker” 202 represents a distinct function, rule, module, object and/or other like pipeline part which handles and/or processes one or more operations and/or interactions with one specific ecosystem component and/or network element.

Suitably, each pipeline 200 has a life cycle of defined states. For example, suitable states for the pipeline 200 include: “created” in which the pipeline has been defined and/or established but not yet valid for operation; “valid” in which the pipeline is “created” and valid for operation, but not specifically activated; “activated” in which a created and valid pipeline is selected for execution of the defined workflow; “inactive” in which an otherwise created and valid pipeline is defined but not selected for execution of the defined workflow (but it can be reactivated); and “invalid” in which the pipeline cannot be used (i.e., it can be deleted). Suitably, each pipeline 200 has a priority (e.g., as compared to other pipelines) and a version. In practice, the pipeline 200 has an entry rule with potentially multiple inputs, multiple outputs and multiple conditions and a state that can be verified by the user's data session and/or context. Of course, each rules evaluation will lead to a given action and/or decision.

In one suitable embodiment, the RE 11 is provisioned and/or arranged to permit the configuration of rules to select one of a plurality of pipelines defining a workflow that the user's context will go through based on several criterions (e.g., such as the user's data plan, usage context, etc.). In practice, the pipelines configured in and/or by the RE 11 reflected a desired workflow of business and/or other processes. A pipeline 200 defined in and/or by the RE 11 suitably includes a list of workers 202 and their scheduled execution sequence within the pipeline 200, with adequate priorities and rules to control the flow from one worker 202 to the next. Each interaction with one component of the ecosystem or with one network element is suitable executed by one worker 202 that performs a set of operations (or interactions) resulting from the evaluation of configurable rules by the RE 11. Each interaction of task may have multiple inputs, multiple outputs and a set of rule(s) and/or conditions. Optionally, the priority between rules is also defined. In practice, each rule is a set of conditions that can be evaluated by the RE 11 using various inputs to lead to an action and/or decision and multiple outputs may result from the rule evaluation.

As defined in and/or by the RE 11, each worker 202 inside a pipeline 200 may have: multiple inputs, multiple outputs, multiple conditions and operations/actions to be executed; and an entry rule with potentially multiple inputs, multiple outputs, multiple conditions and a state that is verifiable by the user's data session and/or context. Suitably, rule evaluation leads to a decision to execute the worker's configured operations and output state. In practice, a worker 202 can be either enabled or disabled within a pipeline 200 and each worker 202 within a pipeline 200 has a priority and a version.

As with the pipeline 200, each worker 202 has a life cycle of defined states. For example, suitable states for the workers 202 include: “enable” in which the worker 202 is enabled for operation in the pipeline 200; “disabled” in which the worker is disabled from operation in the pipeline 200; “scheduled” in which the worker 202 is scheduled for operation in the pipeline 200; “running” in which the worker 202 is currently triggered for execution in the pipeline 200; and “executed” in which the worker 202 has already been executed within the pipeline 200.

In practice, the RE 11 is provisioned and otherwise arranged such that the pipeline 200 and workers 202 therein may be selectively configured and managed. For example, one may add, deleted, modify, enable and/or disable either an entire pipeline 200 and/or selected workers 202. In connection with a pipeline 200, the properties, e.g., including sequence of workers 202, their priorities, their entry rules, etc. may be modified as desired. Similarly, in connection with workers 202, their properties, e.g., rules, states, priority, etc. may also be modified as desired. Similarly, individual rules may likewise be added, deleted, enabled, disabled and/or modified. Modification of rules can alter various properties thereof, e.g., including their input parameters, output parameters, conditions and/or actions.

The RE 11 is configured, provisioned and/or otherwise arranged to configure rules for workflow interactions with a set of ecosystem components. For example, interactions with the OCS 10 can be used for real time data event and session rating and charging. In another example, interactions with the PCRF 16 provide for policy (e.g., QoS and/or bandwidth) management. In particular, for example, it may be possible to provide a notification in response to PCRF interrogation about a specific subscriber's policy charging report and/or provide a notification to the subscription to receive the policy charging report for this subscriber when usage consumption has changed. In another example, interactions with a M-Wallet system may relate to content purchases. In this case, it may be able to debit, credit, cancel and/or commit the content purchase operations on a user's M-Wallet account. In still another example, interactions may take place with a zone management and/or yield management system related to dynamic pricing based on an origin cell's discount level, load level and/or associated validity period for the discount. In this case, an interrogation of the zone management and/or yield management system may retrieve the discount level and/or cell load for the origin cell from which the subscriber has initiated his data session. In still a further example, interaction may be had with a digital management system and/or the content provider's AS 14 allowing for the importing of a meta-model including a definition of the content provider (i.e., subscription definition, tariff definition, usage context, etc.) and exporting it towards the OCS 10 for offer definition. In this case, the content provider's sponsored data offer may be received and their definition on the OCS 10 may be requested, as well as the management of end user subscriptions to these data plans. In yet one more example, interaction may be with a smart self-care client or the like. In this case, the user's interactions can be employed which enable interaction with various charging functions, e.g., such as online subscriptions, consumption follow-up, Advise of Change (AoC), top-up, notification, etc.

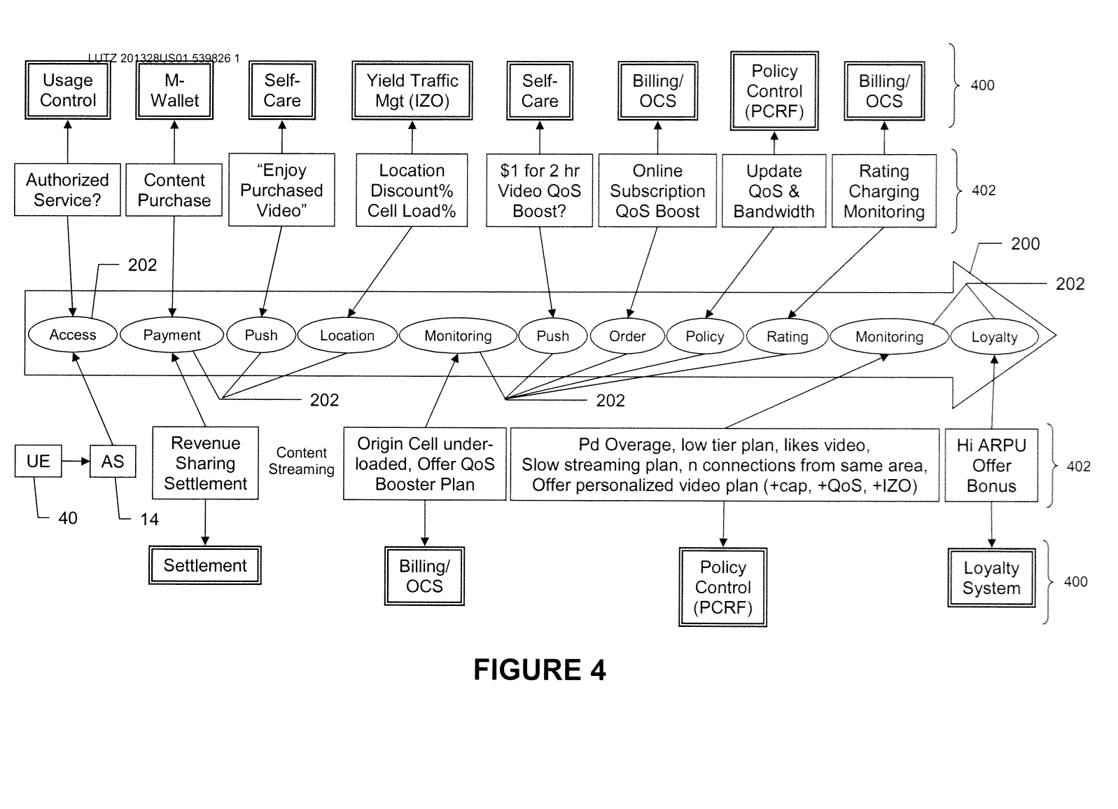

By way of example only, and without limitation, reference in now made to FIG. 4. In this example, there is shown an exemplary pipeline 200 including a plurality of workers 202 interacting with a plurality of diverse ecosystem components and/or network elements 400. As shown, the workers 202 are represented as ovals within the pipeline 200; the various diverse ecosystem components and/or network elements 400 are represented in boxes outlined with a double line; and the decisions, functions and/or interactions 402 in each particular case are represented in boxes outlined with a single line. This example, shows one smart policy orchestration using a configurable pipeline 200 of workers 202 in accordance with aspect of the present inventive subject matter.

As shown, a user 500 employs their UE 40 to purchase a video clip or to steam a video from a content provider's AS 14. Accordingly, as per configurable rules, the “access” worker 202 interacts with a first ecosystem component 400 (in this case, a usage control component, e.g., such as a subscriber profile repository (SPR)) to check if the user is entitled to access this service, e.g., and if so when, where, how, etc.

Assuming the user is entitled to access, again according to the configured rules, the next “payment” worker 202 interacts with a second ecosystem component 400 (in this case an M-Wallet system) to determine a payment account of the user to use for the purchase. Additionally, the “payment” worker 202 may also interact with a third ecosystem component 400 (in the case a settlement system) to determine if there is any revenue sharing and/or otherwise process any settlement as appropriate.

Having completed the purchase, according to configurable rules, a next “push” worker 202 may interact with a next ecosystem component (in this case a self-care system) to notify the user of a successful purchase with a message such as “enjoy your purchase video.” In this case, the notification may be made based on the user's device features, e.g., device type, OS type, etc., which can be obtained from the interaction with the self-care system.

Next (again according to the configurable rules), a “location” worker 202 interacts with a next ecosystem component 400 (in this case, e.g., a zone management and/or yield management system) when the user starts the video download or steaming data session, e.g., to determine the origin cell load level and/or cell discount level.

Having deduced, e.g., that the cell is under loaded, a “monitoring” worker 202 can (according to the configurable rules) interact with a next ecosystem component 400 (in this case an offer database and/or offer intelligence) to determine if the user should be presented with an applicable offer. Assuming a suitable offer exists (e.g., for a $1.00 charge receive a 2 hour QoS boost), a next “push” worker 202 interacts (according to configurable rules) with a next ecosystem component 400 (in this case the self-care system) to push the offer to the user's device 40.

Provided the user accepts the offer, according to the configurable rules, a next “order” worker 202 interacts with the next ecosystem component 400 (in this case the OSC 10) to provide an online subscription to the QoS boost, and a next “policy” worker 202 interacts with the next ecosystem component 400 (in this case a PCRF 16) to update/upgrade the QoS and/or bandwidth provided to the user.

Again according to the configurable rules, a next “rating” worker 202 interacts with a next ecosystem component 400 (in this case the OSC 10) to monitor, rate and charge for the transport of data over the operator's network in accordance with the user's data session. Of course, in some case this transport may be free of charge or sponsored by the content provider or there may be a split charge between the user and the content provider. In this case, configurable rules will allow the system to manage data session monitoring according to whether it is to be counted from the user's account or if it is sponsored totally by the content provider or partially.

Suitably, at the end of the session, a further “monitoring” worker 202 may interact with another ecosystem component 400 (this time, e.g., a reporting and analytics system) to generate a call detail record (CDR) including information such as the user paid an additional upcharge, has a low tiered plan, likes videos, slow streaming plan, has made a number of connections from the same area, etc. Accordingly, there may be proposed to the user a more personalized data plan fit the user's particular circumstances, for example, with a zoning feature, with a higher cap and/or QoS. Of course, the upgraded plan may come with an additional fee from the network operator. This plan can be pushed to the user at the end of the session, e.g., via a smart client provisioned to handle online subscriptions with higher QoS, higher data allowance thresholds, and maybe with a home zone subscription and adapted tariff for digital video services.

In yet one further step, a next “loyalty” worker 202 may interact with a next ecosystem component 400 (in this case a loyalty management system) if the operator decides to award a bonus to this user for the video content purchase and/or streaming.

Again, FIG. 4 illustrates but one of many examples. The pipeline 200 and workers 202 may in practice be configured to handle any of a variety of different scenarios. In another example, the pipeline and/or workers can be configured such that during a user's data session the system is congestion aware and contributes to the management thereof while at the same capitalizing on knowledge of the subscriber and providing care to enhance the relationship between the subscriber and the network operator. For example, smart monitoring workers may be utilized to detect that a steaming session is slow (e.g., based on reported used quantity being less than granted quantity and validity time expiry) and in turn push a notification according to the user's device and/or device features and/or subscriber knowledge to switch the session to a different loading environment or delay download or use a WiFi-offload download and/or potentially offer a discount for the slow download or for switching.

In another example, various policy dimensions can be used to create differentiation and enable more data plans. For example, based on values derived from detecting a user's device, a network operator can offer multi-device data plans where an end user can: share a data plan allowance among different devices; specify maximum allowances according to the used device; the system can perform different behaviors according to the type of device used (e.g., allow overages or not); the system can request PCRF to apply different bandwidth according to the current device; the OSC can decide on different tariffs, discounts, bonuses and/or promotions according to the device; use different notifications according to the device; and so on. In the same way, a network operator may offer a family data plan or group/company data plan with multiple devices and apply policies (tariff, discount, bonus, overage, fair usage of soft cap usage limits with QoS downgrade, hard cap of spending limits with access termination, ec.) according to the member, used application, location and/or device.

In any event, it is to be appreciated that the interactions described are performed in real time to enable the derivation of more value from the network and create differentiation through multiple dimensions of policies.

While described above with respect to specific examples and/or embodiments, it is to be appreciated that various alternatives are contemplated. For example, it is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, analysis, methods, functions, elements and/or components described herein may suitably be implemented via hardware, software, firmware or a combination thereof. For example, the various elements and/or nodes may include a processor, e.g., embodied by a computing or other electronic data processing device, that is configured and/or otherwise provisioned to perform one or more of the tasks, steps, processes, analysis, methods and/or functions described herein. For example, one or more computers or servers or other electronic data processing devices may be employed in the system and may be provided, supplied and/or programmed with a suitable listing of code (e.g., such as source code, interpretive code, object code, directly executable code, and so forth) or other like instructions or software or firmware (e.g., such as an application to perform and/or administer the processing and/or image analysis described herein), such that when run and/or executed by the computer or other electronic data processing device one or more of the tasks, steps, processes, analysis, methods and/or functions described herein are completed or otherwise performed. Suitably, the listing of code or other like instructions or software or firmware is implemented as and/or recorded, stored, contained or included in and/or on a non-transitory computer and/or machine readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, analysis, methods, functions, elements and/or components described herein may be implemented on and/or embodiment in one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, analysis, methods and/or functions described herein can be used.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred and/or other embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for creating a configurable workflow in a mobile telecommunications network ecosystem including a plurality of diverse ecosystem components, the method comprising:
establishing a pipeline that defines the workflow through which a user's data session is processed; and
defining a set of workers within the pipeline that sequentially interact in real time with the ecosystem components.

2. The method of claim 1, wherein each worker in the set of workers interacts with one ecosystem component.

3. The method of claim 1, wherein the pipeline is established within a rules engine which is used to configure the pipeline.

4. The method of claim 3, wherein the workers are further configurable by the rules engine.

5. The method of claim 4, wherein each worker can have a set of multiple inputs, a set of multiple conditions and a set of multiple outputs based on the inputs and evaluation of conditions by the rules engine.

6. The method of claim 3, wherein the rules engine is incorporate in an online charging system.

7. The method of claim 1, said method further comprising:
establishing a plurality of pipelines; and
selecting one of the plurality of pipelines to define the workflow through which a user's data session is processed.

8. The method of claim 7, wherein the output of a preceding worker affects a behavior of a subsequent worker in the same pipeline.

9. An apparatus that executes the method of claim 1.

10. A non-transitory machine-readable medium including a computer program which when executed performs the method of claim 1.

11. A rules engine for creating a configurable workflow in a mobile telecommunications network ecosystem including a plurality of diverse ecosystem components, the rules engine comprising:
a pipeline defined therein that defines the workflow through which a user's data session is processed; and
a set of workers defined within the pipeline that sequentially interact in real time with the ecosystem components.

12. The rules engine of claim 11, wherein each worker in the set of workers interacts with one ecosystem component.

13. The rules engine of claim 11, wherein the pipeline is configurable by the rules engine.

14. The rules engine of claim 13, wherein the workers are further configurable by the rules engine.

15. The rules engine of claim 14, wherein each worker can have a set of multiple inputs, a set of multiple conditions and a set of multiple outputs based on the inputs and evaluation of conditions by the rules engine.

16. The rules engine of claim 13, wherein the rules engine is incorporate in an online charging system.

17. The rules engine of claim 11, said rules engine further comprising:
a plurality of pipelines defined therein; and
wherein the rules engine is configured to select one of the plurality of pipelines to define the workflow through which a user's data session is processed.

18. The rules engine of claim 17, wherein the output of a preceding worker affects a behavior of a subsequent worker in the same pipeline.
